(19) United States
(12) Patent Application Publication
(10) Pub. No.: US 2004/0010566 A1
(43) Pub. Date: Jan. 15, 2004

(54) SYSTEM AND METHOD FOR ESTIMATING THE GEOGRAPHIC LOCATION OF AN INTERNET USER

(75) Inventor: Dante Monteverde, Barrington Hills, IL (US)

Correspondence Address: SEYFARTH SHAW, 55 EAST MONROE STREET, SUITE 4200, CHICAGO, IL, 60603-5803, US

(73) Assignee: EMERGENCY 24, INC., Chicago, IL (US)

(21) Appl. No.: 10/604,147

(22) Filed: Jun. 27, 2003

(51) Int. Cl. G06F 15/173

(52) U.S. Cl. 709/217; 709/224

(57) ABSTRACT

A system and method of estimating an Internet user's geographic location is disclosed. The method includes tracking the Internet user's visits to at least one Internet site promoting a business having a business geographic location to define a visited Internet site, determining the business geographic location of the business promoted by the visited Internet site to define a matched business location, and estimating the Internet user's geographic location to be at least adjacent to the matched business location.

### BACKGROUND OF INVENTION

The present invention relates generally to a system and method for estimating the geographic location of an Internet user and, more particularly, to a system and method for displaying Internet search results found by a search engine that are geographically relevant to the Internet searcher.

The development of the Internet and the World Wide Web (the “web”) has allowed Internet users to access information from around the world with unfettered ease. Information can now be accessed in seconds. To assist in locating specific information, it is well known that search engines can be used to search for documents or web sites of interest to an Internet user. However, it has become increasingly difficult to find not just relevant information in terms of content, but also as to the geographic location of the Internet user.

For example, an Internet user in need of car repair conducting a keyword search in San Francisco for “automobile repair” may find the results containing information for automobile repair shops in Florida. Generally, in order for the user to determine where the automobile repair shop is located, the user would need to review each web site displayed in the returned results list. Since the Internet user is probably not interested in automobile repair shops in Florida, sorting through the results to find a web site that provides services or goods located near the user, in this situation San Francisco, can be cumbersome.

This problem is exasperated with well-known “pay-per-click” search engines, where web site owners pay a fee each time an Internet searcher clicks on a hyperlinked advertisement or search result, thereby forwarding the searcher to the web site owner's web site. Currently there are no methods to verify that an Internet user following the hyperlink is geographically near the web site owner, and thus capable of using the goods or services of the web site owner. As such, web site owners must pay for Internet users who view their web site though a “pay-per-click” search engine, even though the user is not geographically capable to use the web site owner's goods or services. For example, a doctor specializing in laser eye surgery in the Chicago area who actively bids for the keywords “laser eye surgery” through a “pay-per-click” search engine cannot limit his advertising specifically to Internet searchers in the Chicago area, and thus wastes money by being displayed and viewed by someone in Los Angeles. Even though the Internet user in Los Angeles could not use the services of the doctor in Chicago, the doctor must still pay for the user viewing his site via the “pay-per-click” searching system.

It is well known that a geographic location of an Internet protocol address (“IP address”) can be approximated. U.S. Pat. No. 6,377,961 teaches the use of a method for accomplishing this. However, this method is limited to providing a geographic estimate of the country, or possibly the state, for the server on which a web site resides. As such, this method of estimating geographic location has many limitations. For example, it is plausible that when an Internet user accesses the Internet, his Internet Access Provider randomly assigns him an IP address. This random assignment has absolutely no bearing upon the location of the Internet user. As such, an Internet user in New York may be assigned an IP address by his Internet Access Provider that is located in California. In such a scenario, even though the user is located in New York, his assigned IP address may indicate he is located in California.

It is also well-known that an Internet user's location can be approximated by tracing the user's IP address through a trace route function that is capable of tracing the user's route through various Internet servers to narrow the user's location. However, a limitation to such a method is that it consumes time and vast bandwidth to accurately approximate a user's location.

### SUMMARY OF INVENTION

It is an object of the present invention to provide a system and method of reliably estimating an Internet user's geographic location.

It is a further object of the present invention to provide a system and method for displaying Internet search results that are geographically relevant to the searcher.

Yet another object of the present invention is to control the geographic designation a web site may have, thus ensuring that only geographically prospective Internet users may view the web site.

The present application discloses a unique and novel method and system for estimating the geographic location of an Internet user. The method includes tracking the Internet user's visits to at least one Internet site promoting a business having a geographic location, determining what the geographic location of that business is, and estimating the Internet user's geographic location to be at least adjacent to the geographic location of the business promoted by the visited Internet site. Once the geographic location of the Internet user is estimated, the information may be compiled within a database and accessed via a cookie disposed on the Internet user's computer for future reference.

To determine the business geographic location of the visited Internet site, the method may include a look-up database having respective business geographic location information for a plurality of Internet sites. As such, when the Internet user visits an Internet site, the visited Internet site can be cross-matched to geographic location information for that particular Internet site in the look-up database.

In an embodiment, the present application also includes a method of receiving a search request from the Internet user and providing a search results list based upon the estimated geographic location of the Internet user. As such, only geographically relevant businesses promoted on Internet sites will be provided to the Internet user via the search results list. A “pay-per-click” system, where each respective Internet site may be geographically categorized and prioritized based upon the amount of money each Internet site is willing to pay in order to be displayed, may also be provided.

### DETAILED DESCRIPTION

The present application discloses a system and method for estimating the geographic location of an Internet user. The method includes tracking the Internet sites that promote a business, including goods or services, that the Internet user visits to define at least one visited Internet site, determining the approximate or actual geographic location of the business that is promoted by the visited Internet site to define a matched business location, and then estimating the Internet user's location to be at least adjacent to the matched business location.

As such, the present application uses the theory that, in order to initially estimate the Internet user's location, the Internet user is visiting Internet sites that promote businesses that have geographic relevance to the Internet user. While it is anticipated that the Internet user may visit a plurality of Internet sites, some promoting a business having a geographic location not relevant to the Internet user, it will be appreciated that the quantitative teaching of Internet sites visited would conclude that the most common geographic location of the businesses is probably the geographic location of the Internet user. For example, if an Internet user visits five Internet sites, four of the sites promoting businesses in San Francisco and the remaining site promoting a business in New York, the calculated business geographic location would be San Francisco since it was the most common geographic location associated with the visited Internet sites.

In an embodiment, a look-up database may be provided that includes respective business geographic location information for a plurality of Internet sites. An operator, owner or some one else associated with the Internet site or the business promoted on the Internet site may dictate the actual or wanted business geographic location information that is input into the database. In such an embodiment, the respective business geographic location of the visited Internet sites may be determined by matching each visited Internet site to an Internet site in the database, thereby defining a matched Internet site, and consequently equating that visited Internet site's business geographic location to be the same as the business geographic location of the matched Internet site. If there are greater than three visited Internet sites, the matched business location can be determined by calculating the most common matched business geographic location.

A method of tracking or calculating the amount of time the Internet user visits an Internet site may also be employed. It will thus be appreciated that Internet sites that are not viewed for a fixed amount of time by the Internet user will be disregarded in estimating the Internet user's geographic location because such Internet sites would be deemed not geographically relevant to the Internet user. Other methods may be employed in determining if an Internet user is interested in a specific Internet site, such as calculating or tracking the amount of internal hyperlinks the Internet user follows.

In an embodiment, once the Internet user's geographic location is estimated, a cookie having a unique identifier may be disposed on the Internet user's computer system. A database may then be provided to store the estimated geographic location of the Internet user and correlate or associate it to the cookie in a well-known manner. As such, each subsequent time the Internet user accesses the Internet, the cookie will readily determine the Internet user's estimated geographic location. It will be appreciated that the Internet user database will be dynamic in that the estimated geographic location of the Internet user may change if, for example, the estimated geographic location is different than that stored within the Internet user database.

In an embodiment, after estimating the Internet user's geographic location, an Internet search request may be received from the Internet user and only geographically relevant Internet sites, or Internet sites promoting a business having a geographic location at least adjacent to the Internet user's estimated geographic location, are displayed to the Internet user via a search results list. In another embodiment, an Internet search request received from the Internet user may create a search results list that prioritizes the returned Internet sites based upon the geographic relevance of each respective Internet site to the estimated geographic location of the Internet user.

In yet another embodiment, a “pay-per-click” system may be employed. In such an embodiment, promoters or owners of businesses promoted on respective Internet sites may bid for prioritization in a geographically relevant search results list. Further, the promoter or owner may select which Internet users, based primarily upon estimated geographic location, may access the Internet site. For example, the promoter or owner, promoting a business in Chicago, may restrict its Internet site to only be displayed in a search results list where the Internet user's estimated geographic location is Chicago. In such an embodiment, the promoter or owner thus decreases the amount of Internet users that do not have the probability of using the promoted business” goods or services due to geographic distances between the Internet user and the business.

It will be appreciated that the benefits of the present application apply to any type of search engine and is not necessarily limited to “pay-per-click” systems. It will further be appreciated that the present application provides benefits not only to the businesses or Internet sites being displayed in the search results list in the form of increased visibility, but also to the Internet user in that the amount of time necessary to locate geographically relevant businesses or Internet sites is dramatically reduced.

In another embodiment, a method of displaying geographically relevant Internet search results based upon the geographic location of an Internet user is disclosed. The method includes providing a database having respective business geographic location information for a plurality of Internet sites, determining the geographic location of the Internet user, receiving an Internet search request from the Internet search user, and displaying search results for Internet sites having a geographic business location adjacent to the geographic location of the Internet user.

The respective business geographic location information may include allowing the Internet site operator specify the business geographic location information. The geographic location of the Internet user be determined by allowing the Internet user to manually specify the geographic location of the Internet user. Once the geographic location of the Internet user has been determined, it may be stored within a database and a complementary cookie having a unique identifier may be disposed on the Internet user's computer for each and quick determination of the geographic location of the Internet user in the future.

A system for estimating the geographic location of an Internet user is also disclosed. The system includes a database having respective business geographic location information for a plurality of Internet sites, a means for tracking the Internet sites that the Internet user visits to define a plurality of visited Internet sites, and a means for correlating the Internet user's geographic location to the business geographic location information obtained from the visited Internet sites.

The means for correlating the Internet user's geographic location may include a system to compare the visited Internet sites with the Internet site information contained within the database to find a corresponding match. If the visited Internet site is matched with an Internet site in the database, the visited Internet site's business geographic location is determined to be the same as the business geographic location information contained within the database for that respective, matched visited Internet site. The means for correlating may also include a means for quantitatively determining a most popular geographic location by quantitatively prioritizing the business geographic location information of the visited Internet sites. As such, the business geographic location with the most visited Internet sites is prioritized the highest.

In an embodiment, the means for tracking the Internet sites the Internet user visits includes calculating the time the Internet user spends on each respective site and disposing a cooking on the computer system that the Internet user is using to access the Internet.

The matter set forth in the foregoing description is offered by way of illustration only and not as a limitation. While particular embodiments have been described, it will be apparent to those skilled in the art that changes and modifications may be made without departing from the broader aspects of applicant's contribution and invention. The actual scope of the protection sought is intended to be defined in the following claims when viewed in their proper perspective based on any prior art.

1. A method of estimating an internet user's geographic location, comprising:
tracking the Internet user's visits to at least one Internet site promoting a business having a business geographic location thereby defining a visited Internet site;
determining the business geographic location of the business promoted by the visited Internet site thereby defining a matched business location; and
estimating the Internet user's geographic location to be at least adjacent to the matched business location.

2. The method as claimed in claim 1 further comprising providing a database having business geographic location information for a plurality of Internet sites.

3. The method as claimed in claim 2 wherein the business geographic location information is determined by an operator of each respective Internet site.

4. The method as claimed in claim 2 wherein the step of determining the business geographic location of the business promoted by the visited Internet site includes matching the visited Internet site to an Internet site in the database thereby defining a matched Internet site and defining the matched business location to be the respective business geographic location of the matched Internet site.

5. The method as claimed in claim 4 wherein the matched business location is determined by calculating the business geographic location most often matched.

6. The method as claimed in claim 5 wherein the step of tracking the Internet user's visits to at least one Internet site having a business geographic location includes tracking the amount of time the Internet user remains on the Internet site.

7. The method as claimed in claim 6 wherein the step of tracking the Internet user's visits to at least one Internet site having a business geographic location includes disposing a cookie having a unique identifier on a computer system that the Internet user is using to access the Internet.

8. The method as claimed in claim 7 further comprising providing an Internet user database for recording the matched business location and correlating it to the cookie.

9. A method of estimating an Internet user's geographic location, comprising:
providing a database having respective business geographic location information for a plurality of Internet sites;
tracking the Internet user's visits to a plurality of Internet sites thereby defining a plurality of visited Internet sites;
matching at least one visited Internet site to an Internet site in the database thereby defining a matched business geographic location;
comparatively determining the matched business geographic location having the most matches thereby defining a most popular business geographic location; and
estimating the Internet user's geographic location to be adjacent to the most popular business geographic location.

10. The method as claimed in claim 9 wherein an operator of the respective Internet site determines the business geographic location information.

11. The method as claimed in claim 9 wherein the step of tracking the Internet user's visits to a plurality of Internet sites includes tracking the amount of time the Internet user remains on the Internet site.

12. The method as claimed in claim 11 wherein the step of tracking the Internet user's visits to a plurality of Internet sites includes disposing a cookie having a unique identifier on a computer system that the Internet user is using to access the Internet.

13. The method as claimed in claim 12 further comprising providing an Internet user database for recording the most popular business geographic location and correlating it to the cookie.

14. A system for estimating the geographic location of an Internet user, comprising:
a database having respective business geographic location information for a plurality of Internet sites;
a means for tracking Internet sites that the Internet users visits, thereby defining a plurality of visited Internet sites; and
a means for correlating the Internet user's geographic location to the business geographic location information obtained from the visited Internet sites.

15. The system as claimed in claim 14 wherein the means for tracking Internet sites includes disposing a cookie on a computer system that the Internet user is using to access the Internet.

16. The system as claimed in claim 15 wherein the means for estimating the Internet user's geographic location includes a system for matching each visited Internet site with an Internet site in the database and assigning each visited Internet site the respective corresponding business geographic location information for the matched Internet site in the database.

17. The system as claimed in claim 16 wherein the means for estimating the Internet user's geographic location further includes a system for quantitatively determining a most popular geographic location.

18. The system as claimed in claim 17 a means for estimating the Internet user's geographic location includes a system for estimating the Internet user's geographic location to be the most popular geographic location.

19. A method of providing Internet search results based upon the estimated geographic location of an Internet user, comprising:
providing a database having respective business geographic location information for a plurality of Internet sites;
tracking the Internet user's visits to a plurality of Internet sites thereby defining a plurality of visited Internet sites;
matching at least one visited Internet site to an Internet site in the database thereby defining a matched business geographic location;
comparatively determining the matched business geographic location having the most matches thereby defining a most popular business geographic location;
estimating the Internet user's geographic location to be adjacent to the most popular business geographic location thereby defining an Internet user location;
receiving an Internet search request from the Internet search user; and
displaying search results for Internet sites having a geographic business location adjacent to the Internet user geographic location.

20. The method as claimed in claim 19 wherein the step of tracking the Internet user's visits to a plurality of Internet sites includes disposing a cookie having a unique identifier on a computer system that the Internet user is using to access the Internet.

21. The method as claimed in claim 20 further comprising providing a database for recording the Internet user location and correlating it to the cookie.

22. The method as claimed in claim 19 wherein the step of displaying search results for Internet sites having a geographic business location adjacent to the Internet user location includes prioritizing the search results based upon the amount of money each respective Internet site is willing to pay for being displayed.

23. The method as claimed in claim 22 wherein the amount of money each respective Internet site is willing to pay for being displayed includes a pay-per-click bidding system.

24. A method of displaying geographically relevant Internet search results based upon the geographic location of an Internet user, comprising:
providing a database having respective business geographic location information for a plurality of Internet sites;
determining the geographic location of the Internet user;
receiving an Internet search request from the Internet search user; and
displaying search results for Internet sites having a geographic business location adjacent to the geographic location of the Internet user.

25. The method as claimed in claim 24 wherein the step of providing a database having respective business geographic location information for a plurality of Internet sites includes allowing the Internet site operator specify the business geographic location information.

26. The method as claimed in claim 24 wherein the step of determining the geographic location of the Internet user includes the Internet user manually specifying the geographic location of the Internet user.
